(19) United States
(12) Patent Application Publication
(10) Pub. No.: US 2015/0197426 A1
(43) Pub. Date: Jul. 16, 2015

(54) MESOPOROUS, HIGHLY ORDERED MAGNESIUM AND NIOBIUM BASED TERNARY OXIDE COMPOUND, PROCESS FOR ITS PREPARATION AND USES

(71) Applicants: UNIVERSITA DEGLI STUDI DI SASSARI, Sassari (SS) (IT); UNIVERSITA AUTONOMA DE BARCELONA (UAB), Bellaterra CerdanyonadelValles)Barcelona (ES); INSTITUCIO CATALANA DE RECERCA I ESTUDIS AVANCATS (ICREA), Barcelona (ES)

(72) Inventors: Gabriele Mulas, Sassari (SS) (IT); Sebastiano Garroni, Sassari (SS) (IT); Elisa Tolu, Sassari (SS) (IT); Eva Maria Pellicer Vila, Oliana (Lleida) (ES); Maria Dolors Baro Marine, Sant Cugat del Valles (Barcelona) (ES); Jordi Sort Vinas, Terrassa (Barcelona) (ES)

(21) Appl. No.: 14/415,479

(22) PCT Filed: Jun. 28, 2013
(86) PCT No.: PCT/IT2013/000179

§ 371 Date: Jan. 16, 2015

(30) Foreign Application Priority Data
Jul. 19, 2012 (IT) RM2012A000345

(51) Int. Cl. C01G 33/00

(52) U.S. Cl. CPC C01G 33/00

(57) ABSTRACT

The present invention concerns a Magnesium (Mg) and Niobium (Nb) ternary oxide with very high morphological order degree having Mg_{11.1}Nb_{22.2}O_{66.7} atomic percentage composition which, due to the chemical composition and morphological and nanostructural properties, can be used in various fields of technological interest, specifically it is suitable to be used as dielectric material for capacitors, as material for hydrogen confinement and energy storage.

The present invention concerns a magnesium (Mg) and niobium (Nb) based highly ordered mesoporous ternary oxide compound, process for its preparation and uses. In particular, the present invention concerns a Magnesium (Mg) and Niobium (Nb) ternary oxide with a highest degree of morphological order and amorphous structure, having Mg_{11.1}Nb_{22.2}O_{66.7} atomic percentage composition, which, due to the chemical composition, morphological and nanostructural properties, can be used in various fields of technological interest. Specifically it is suitable to be used as dielectric material for capacitors, as material for hydrogen confinement and energy storage.

The interest towards chemical systems consisting of mixed oxides based on Magnesium and Niobium (magnesium niobates), of general formula MgₓNb_{y}O_{z} where x, y and z represent the stoichiometric coefficients, has started since the early 70's [1] and today continues to grow up thanks to their potential applications such as ceramic dielectric materials in capacitors [2, 3]. In the family of magnesium niobate 4 crystallographic phases were identified: MgNb₂O₆, Mg₄Nb₂O₉, Mg₅Nb₄O₁₅ and Mg_{2/3}Nb_{11(1/3})O₂₉ which were prepared by heat treatments under different conditions [1, 4]. Among them, the first two show a greater stability at room temperature and they have been paying increasing attention. Columbite, MgNb₂O₆, has been widely studied due to the promising dielectric properties [5] and as precursor for the synthesis of Pb(Mg_{1/3}Nb_{2/3})O₃ (PMN) ceramic material [6]. Mg₄Nb₂O₉ shows interesting photoluminescent properties, at room temperature, with possible applications in the field of the design and safety systems (emergency lights) [7]. Recently, various compounds of the class of MgₓNb_{y}O_{z} systems have been also tested in the field of hydrogen storage thank to their suitable interaction with molecular hydrogen favouring the gas absorption and desorption. F. Dolci and coworkers, and Rahman and coworkers, have synthesized various Mg—Nb—O based mixtures by thermal activation of MgO and Nb₂O₅ as an alternative synthesis to compounds obtained from MgH₂+Nb₂O₅ phases when subjected to mechanical treatment [8 9]. Among the prepared materials, Mg₃Nb₆O₁₁ phase displayed a clear and reversible interaction with molecular hydrogen when subjected to specific heat treatments, confirming a key role in catalyzing and favouring gas interaction processes [9]. On the contrary, MgNb₂O₆ and Mg₄Nb₂O₉ compounds result to be totally inert.

The synthesis process of magnesium niobate phases by heat treatment of MgO and Nb₂O₅ precursors at elevated temperatures (>900° C.), does not result easy and totally effective: in fact, the oxide alloying by thermal way leads, in the majority of the cases, to a heterogeneous composition (that is with the presence of different phases of magnesium niobate and Nb and Mg oxides), irregular shapes of grains and large crystallites size characterized by a not unimodal distribution [10]. About this M.W. Rahman and coworkers [9], by calcining at high temperatures (>1000° C.) the starting powders, obtained completely crystalline powders. The same research group, as reported in [8], evidences as the sizes of the coherent diffraction domains (crystallites) of MgₓNb_{y}O_{z} phases are in the range from 150 to 300 nm. In these two papers it is also reported that at the end of the calcination treatment the “impurities” of the starting materials as niobium and magnesium oxide were present.

These structural properties result in an elevated thermodynamic stability and reduced chemical reactivity, which aspects can be characterized in negative terms with respect to the interest fields regarding technological applications. Finally, it is to be pointed out the reduced surface area (that is, the area for mass unit) typical of the materials obtained by means of heat treatments at high temperatures, although in the cited references these data are often not reported. In addition, the calcination performed at elevated temperatures and for several hours, as required for this synthetic way, results too energy expensive. The possible applications of such powders, that could require the production on large scale, therefore have guided the interest towards new synthetic ways, able to reduce the costs and improve the properties of the raw material as required for the above cited possible applications.

The use of mechanochemical techniques, by means of mechanical treatment in high energy ball mills, was studied as a synthetic alternative route or as a pre-treatment to be followed by thermal processes under milder conditions than the aforementioned cited cases [10, 11]. In particular Kong and coworkers [11], by subjecting to mechanical treatment the MgO and Nb₂O₅ powders, obtained an amorphous structure that, by calcination at 700° C., lead to MgNb₂O₆ as single phase, with an average particles size around 1 micron (μm) both in the amorphous and crystalline compounds. Although it seems to offer advantages compared to the simple heat treatment, the mechanochemical process does not assure improvements in terms of surface area (data not reported by the authors but ascribable by the particle sizes).

Recently, a further synthetic approach studied for the preparation of magnesium niobate phases is represented by the sol-gels techniques. In these processes, in general terms, the reagents, in salt form, are hydrolysed in suitable solvents and pH conditions, also resulting in oxidizing-reducing processes. The formation of products in form of colloids or precipitates accompanies the “gel” phase with the progressive elimination of solvent. Sol-gel processes are today widely studied for the manufacturing of ceramic materials, typically metal oxides, at low temperatures. These synthesis procedures offer various advantages, such as the possibility to obtain a single phase with an elevated degree of purity and the opportunity of modulating the particle size and morphology [12].

Sol-gel technique recently was applied also to the production of magnesium niobate and in particular of the MgNb₂O₆ phase, in order to improve the purity and increase the surface area and at the same time drastically reducing the particle sizes.

E. R. Camargo and coworkers [13] have synthesized a crystalline single phase of MgNb₂O₆, by means of calcination, at approximately 900° C., of an amorphous phase obtained through a sol-gel process defined “Polymerized-Complex method”. The authors pointed out, among other things, the value of specific surface area of 12.22 m²/g as result of the preparative route.

Recently, on the other hand, T. H. Fang and coworkers [14] prepared by means of sol-gel technique nanocrystalline MgNb₂O₆ at temperatures lower than 700° C. with particle sizes lower than 100 nm. In addition, Zhang and coworkers [15], in order to decrease the synthesis temperature below 700° C., developed a synthesis protocol that allows to obtain MgNb₂O₆ particles with dimension of approximately 20 nm [15].

Although the continuous progresses with respect to the synthesis of magnesium niobate, it results still far the preparation of materials with microstructural properties to reach high values of surface area, modulate in effective way the porosity, morphological order and electronic parameters. These parameters could result in application properties of high interest.

In the light of these considerations, it is necessary to provide new materials suitable to overcome the disadvantages of the state of the art.

To this regard it must be noticed that the flexibility of sol-gel processes allows an easy integration with other branches of chemistry, like supramolecular one, so to obtain mesostructured materials by means of auto-assembling processes primed by polycondensation phenomena in a solution that contains metallic precursors and surfactants. Among various types of nanostructured materials the so-called mesoporous materials characterized by pore sizes in the 2-50 nanometer (nm) range find large interest. The mesoporous materials seem to offer innovative perspectives in numerous application fields addressing more disparate uses: catalysis, drug preparation, haemodialysis, membranes for chemical analysis, separators (for polluting agents or gas), up to advanced ceramics like gas sensors, waveguides, matrices for nanoconductors, low k dielectric materials, materials for photovoltaic applications. The flexibility of these nanomaterials results, in addition to the opportunity to modulate morphology and pore texture, in the opportunity to be used such as host materials.

A sol-gel method recently applied for the synthesis of mesoporous systems is the EISA process (Evaporation-Induced Self-Assembly). The materials are prepared by hydrolysis with sol-gel method, having a “texture” resulting from the chemical-physical properties of the used surfactant, and that are defined in the step of solvent evaporation accompanying the polycondensation process. Moreover, the synthesis procedure allows the deposition of such materials in thin film, characteristic that confers further additional value for different technological applications [12].

Such technique was never used, until now, for the preparation of the magnesium niobate systems.

The inventors of the present invention now developed a process for the synthesis, by means of EISA technique, of a mesoporous and highly ordered material having MgₓNb_{y}O_{z} formula with x=11.1, y=22.2 and z=66.7 atomic percentage composition. The as prepared material is in the amorphous state, and as a result of heat treatment at 572° C., crystallizes in MgNb₂O₆ phase with quantitative yield. The amorphous material is characterized by an elevated surface area (169,16 m²/g), much more larger if compared to the literature data for the same material obtained according to different synthetic routes (12 m²/g) [13].

The mesoporous oxide of Mg and Nb, MgₓNb_{y}O_{z}, according to the present invention, with x=11.1, y=22.2 and z=66.7 atomic percentage composition, was prepared by EISA technique (Evaporation-Induced Self-Assembly) with a so-called “soft” type method, according to an operating strategy similar to that used by Tokumitsu Katou and coworkers [16] for a different system based on Nb and Ta. Note that the just cited reference concerns the preparation of a different material, with Nb—Ta—O composition, meanwhile none synthesis of the class of analogous compounds based on Mg and Nb and of general formula Mg—Nb—O, was reported.

These methods involve the assembling of the mesoporous matrix starting from a solution where the surfactant, a nonionic co-polymer, results in the formation of micelle forms and the formation of solid metallic oxide occurs starting from the precursors.

Compared to the results obtained in state of the art, the present invention makes use of EISA technique allowing the amount of precursor to be minimized and obtaining high yields of products and purity. In particular, respect to F. Dolci and coworkers [8] manuscript, it is to be pointed out that, in their case, a classic calcination technique is used i.e. thermal annealing at high temperatures (1000° C. for approximately 24 h), consisting essentially of Mg and Nb oxides. By combination of the two precursors at different molar ratios the different crystallographic phases are obtained. Among the disadvantages of this technique, the elevated temperatures and the presence of by-products at the end of the synthesis process are mentioned. Further, it is to be emphasized that the calcination technique at high T results in a substantial growth of grains and particles. Particles with a large dimension and low surface area represent an ulterior obstacle so that such method could be taken in consideration for the production of highly functional magnesium niobate.

On the other hand, it is to be emphasized as, in spite of using a sol-gel technique similar to that of the present invention (13-14-15), the obtained results do not seem to approach those here reported. In fact in the work of Camargo and coworkers, specifically in the abstract section, it is indicated as “high specific surface area”, the surface area obtained for the sample equal to approximately 12 m²/g, a value lower than that reported for the material according to the present invention of a factor to 14. Moreover it is to be remembered that in all the cited works, nanoparticles and nanocrystalline material are mentioned. As it is argued from SEM and TEM images occurring in above cited papers, the known materials are simple particle agglomerates with not defined pores. Such materials do not show significant surface areas neither comparable to those of the material according to the present invention. Moreover, the known materials are not mesoporous. A mesoporous material consists of a large number of pores that drastically increases the specific surface area of the material modifying also its chemical reactivity. A material consisting of nanoparticles is completely different from a mesoporous material, since the particles are completely separated from each other and therefore they do not form pores. A mesoporous material can be also nanocrystalline, but in of the most of the cases the mesoporous structure coincides with an amorphous state of the system. While in the known works the crystallographic structure of MgₓNb_{y}O_{z} is crystalline, the compounds according to the present invention have amorphous structure. Otherwise than crystalline materials, the amorphous materials do not show grain boundaries due to the crystalline domains and therefore do not show the weak areas just resulting from these grain boundaries. In fact the conventional polycrystalline materials are indented, degraded and finally fractured because of the presence of inherent defects known like grain boundaries of crystalline plane dislocations, which are present in large amounts inside a crystalline material and, for metallic materials, act as starting points of oxidation and corrosion. The amorphous materials not having a crystalline structure bearing these defects, have intrinsic properties as elevated elasticity (deformation up to 2% in elastic range, comparable therefore to the technopolymers), elevated hardness and corrosion resistance. Their properties are interesting both from mechanical (particularly hard and tough) and electrical point of view: their resistance, otherwise than crystalline metals, does not change with the temperature.

Based on the above considerations, no work in the current literature, describes a mesoporous and highly ordered magnesium niobate as that obtained according to the present invention with all the advantages resulting from such mesostructure, as for example an elevated surface area and suitability to modulate the pores and to use the same as reactive sites

The advantages of the preparation process of composites according to the invention, in comparison to known synthesis techniques of MgNb₂O₆, consist of low value of operating temperature (40° C. vs 120-130° C.), method reproducibility and consist in obtaining a mesoporous structure stable up to about 600° C.

MgNb₂O₆ is considered today one of the most promising candidates for applications in the field of the instrument components for the production of microwaves and electrolytic capacitors. Such material shows an excellent dielectric capacity and it is moreover used like precursor for the synthesis of well known system used in capacitors like Pb(Mg_{1/3}Nb_{2/3})O₃ (PMN).

Since performance of condenser and capacitor are directly related to the surface area of the used material, powders with high specific surface area allow to reduce the amount of the dielectric material and to affect remarkably the direct costs of the final product.

In this context, the material according to the present invention shows values of dielectric constant (18) at high frequency similar to those reported by Zhang and coworkers and high values (60) at low frequency. The latter value is approximately 2 times than those reported in literature. Moreover, it is to be considered that, at equal dielectric constant, the high surface area of the inventive material, directly affects the capacitor capacity. The material according to the present invention shows a surface area of considerable importance (169 m²/g) if compared with literature data for the same material obtained according to different synthetic route (12 m²/g), that is the material of the present invention shows a surface area approximately 14 times larger than not mesoporous stoichiometrically analogous materials (169 m²/g vs 12 m²/g). Such characteristic is of fundamental importance for use of the material such dielectric, because, compared to up to now studied analogous compounds, at equal volume, it allows to increase the capacitor capacity by 14 times.

Moreover the induced high order degree allows to increase the reactive sites inside of the matrix without to preclude its thermal and mechanical stability. Therefore, the material of the present invention represents an optimal solution for the always increasing market of nanocondensators and nanocapacitors.

The reproducibility of the synthesis technique together with low temperatures used for the production process of the material, affords the material to be used on industrial scale.

Other possible fields of application of the material according to the present invention are:

a) Materials for the hydrogen confinement in solid phase (hydrogen storage materials) as result of the chemical composition, morphological and nanostructural properties. To this, different stoichiometries related to the system are in preparation in order to estimate the H₂ storing properties

b) Materials for energy storage in form of electromagnetic wave in relation to the photoluminescent properties.

The above reported process for the preparation of compounds according to the present invention involves the dependence on various parameters, as the presence and chemical nature of the surfactant, the temperature and the degree of humidity, the chemical nature of Nb and Mg precursors. Such parameters were analyzed and preparations were carried out under various conditions described below in order to verify the role of the surfactant, type of the Nb and Mg metal precursors, relative amounts of such precursors, temperature of evaporation, content of humidity during the process of solvent evaporation, solvent and times of calcination.

Role and Dependence on the surfactant: the formation of an ordered mesostructure in the sol-gel processes is generally considered as result of a polycondensation mechanism of hydrolyzed phases occurring on the surface of the surfactant micelles present in solution. To this regard the indicated chemical systems with the commercial acronyms P123 and F127 were used (P123=PEO₂₀PPO₇₀PEO₂₀, HO(CH₂CH₂O)₁₀₆(CH₂CH(OH)—CH₂O)₇₀(CH₂CH₂O)₁₀₆H, AMW=5800, Sigma. F127: PEO₁₀₆PPO₇₀PEO₁₀₆, HO(CH₂CH₂O)₁₀₆(CH₂CH(OH)—CH₂O)₇₀(CH₂CH₂O)₁₀₆H, AMW: 12.600, Sigma. PEO-PPO-PEO acronym means poly (ethylene oxide)-poly (propylene oxide)-poly (ethylene oxide) belonging to the class of nonionic surfactants as tri-block polymers consisting of polyethylene oxide, polypropylene oxide and polyethylene oxide. The two indicated species differ from each other for the average molecular weight of each block. Both the species belong to the class of nonionic surfactants, assuring a limited interaction with the polycondensing phases, whose properties can facilitate the removal process.

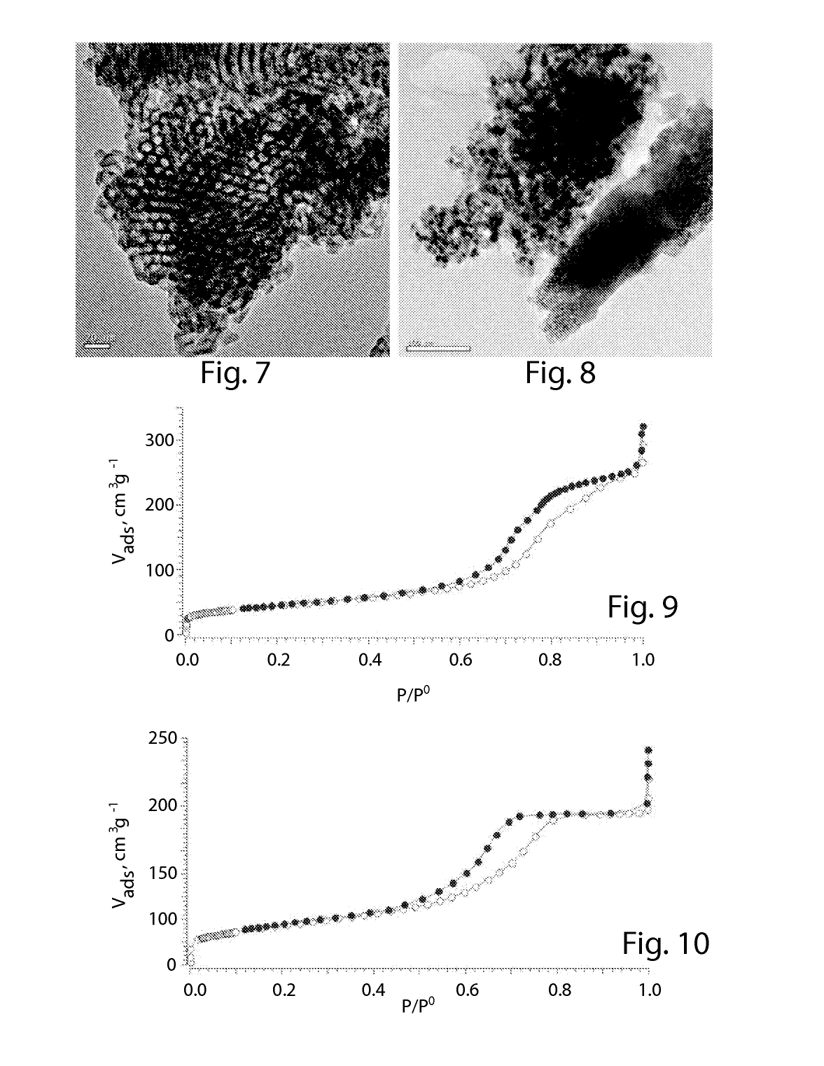

Role of the surfactant during the calcination process: the surfactant can play an important role inducing the formation of the ordered mesostructure avoiding the collapsing phenomena of the porous structure. The experiments outlined a higher order degree in the mesoporous structure of the samples prepared using P123 compound, keeping the other parameters. The order degree was estimated using HR-TEM analysis and porosimetry by Nitrogen physisorption. FIGS. 7 and 8 concern two samples prepared using P123 and F127, respectively.

Role of the chemical nature of Nb and Mg metal precursor: as previously reported, the synthesis procedures reported in the literature for MgNb₂O₆ crystalline phases refer to the use of oxides as Nb₂O₅, MgO, Mg hydroxide and carbonate (Mg(OH)₂, MgCO₃) and Mg nitrate, Mg(NO₃)₂, used according to synthesis route indicated as “columbitic”. In the sol-gel processes, the hydrolysis stage occurs in salt or hydroxyl phases that can affect the pH of the solution. To this, it was pointed out that a slightly acid pH (<7) can play a catalytic role in the polycondensation process. Moreover, the low temperature of the HCl evaporation allows, its easy removal during the gel formation keeping at the same an elevated humidity degree, which is an important property for the auto-assembling process. According to the tests of the inventors MgCl₂, NbCl₅ and Mg(OH)₂ were used. Under the same parameters (chemical nature of the surfactant, temperature, and humidity) the precursor pair MgCl₂ and NbCl₅ formed amorphous phases with ordered mesostructure at lower aging times compared to the NbCl₅ and Mg (OH)₂ precursors pair.

The relative amounts of the precursors can play an important role for the formation of the amorphous phase and, in particular, for the stoichiometry and purity of the crystalline phase obtained after the heat treatment at high temperature that induces the crystallization process.

In order to reach the synthesis of MgNb₂O₆ equilibrium crystallographic phase, the relative amount of the precursors must be “Mg”:“Nb”=1:2, where “Mg”:“Nb” corresponds to the mole number of the metal precursors. The use of different amounts results in the formation of other equilibrium phases. Under such conditions the inventors obtained ordered mesoporous structures with excess of Nb precursor equal to 10% molar.

Role of the evaporation temperature: the solvent evaporation temperature represents an important parameter in the auto-assembling process leading to the formation of the mesostructure. The temperature range examined was 25° C.<T<50° C. Samples treated at 25° C. show a not ordered mesoporous structure, while samples treated at temperatures in the range 40° C.<T<50° C. result in the formation of ordered mesostructures as a function of other parameters (evaporation times, nature of surfactant, nature of solvent and metal precursors, humidity degree).

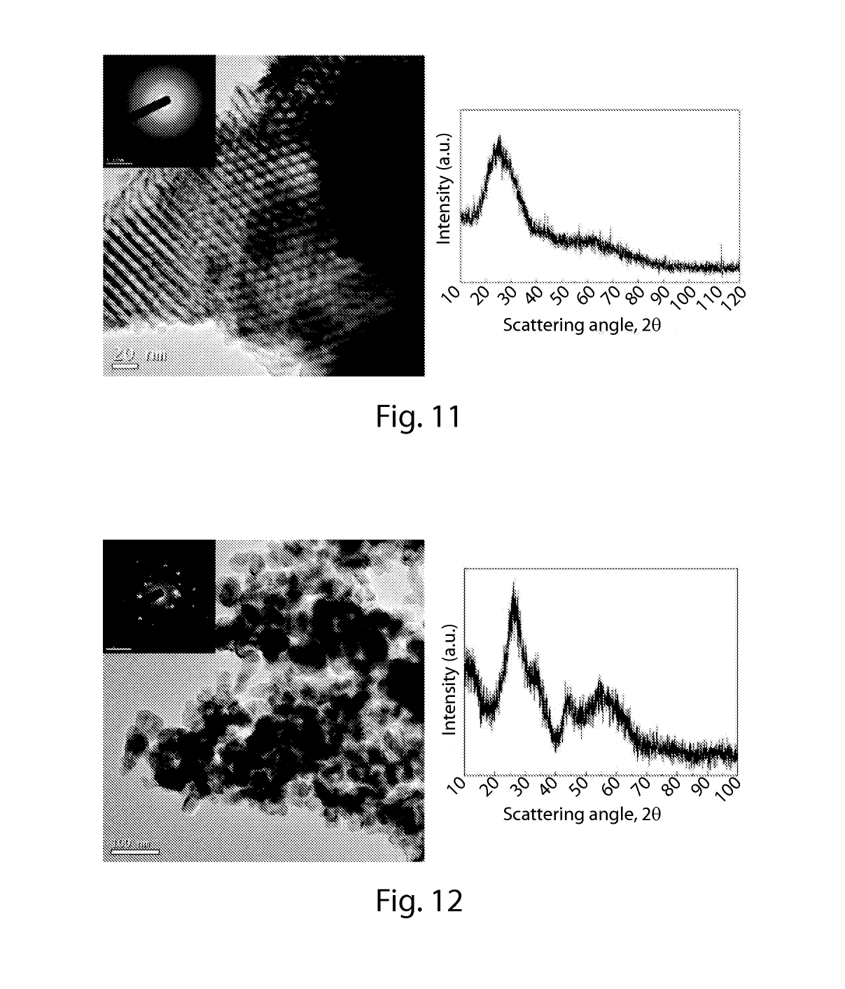

Role of the humidity content during the process of solvent evaporation: the humidity content during the process of solvent evaporation can determine the successful of self-arrangement process and leads to highly ordered mesoporous structures. This depends on the importance of the water in the polycondensation process. The experiments evidenced that the optimal relative humidity value is within 40%-60% range. The humidity value must be maintained constant during all the evaporation process. Tests carried out under uncontrolled humidity conditions, keeping the same experimental parameters, resulted in the formation of not ordered mesoporous structures. TEM and XRD images of samples treated under controlled and uncontrolled humidity conditions are enclosed. (FIGS. 11 and 12 respectively).

Role of the calcination temperature: The samples were treated at 500° and 800° C. 500° C. is the ideal calcination temperature for the material according to the invention because at this temperature it is possible to remove completely the surfactant and in this range the ordered mesoporous structure does not collapse. On the contrary at 800° C. the obtained material is crystalline and the order in the pore structure being lost. The crystallization temperature was estimated by scanning differential calorimeter integrated in a thermogravimetric apparatus. As shown in FIG. 6, the initial weight loss of the sample as indicated with the TG blue line is related to the solvent evaporation. At approximately 570° C. the calorimetric profile (black line) shows the onset of an exothermic event, with the peak located at 620° C., in correspondence of which the material structure changes from amorphous to crystalline state.

Role of solvent and evaporation times: to this, ethanol/water mixtures (EtOH/H₂O) for MgCl₂, NbCl₅ and EtOH/HCl/THF mixture for NbCl₅ and Mg(OH)₂ precursor pairs were used, respectively. Such mixtures were used according to the following compositions:

1) EtOH/H₂O. The authors used two different compositions

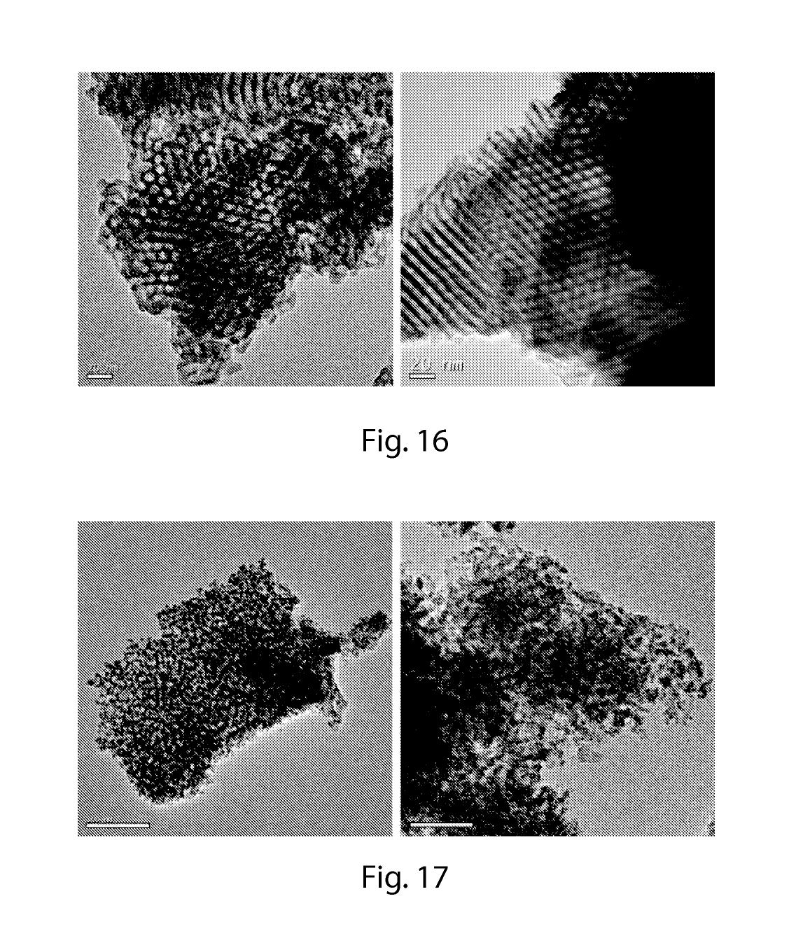

1.a) 0.212 moles of EtOH+0.0167 moles of H₂O (FIG. 16);

1.b) 0.212 moles of EtOH+0.061 moles of H₂O (FIG. 17).

2) EtOH/HCl/THF. the following composition was used:

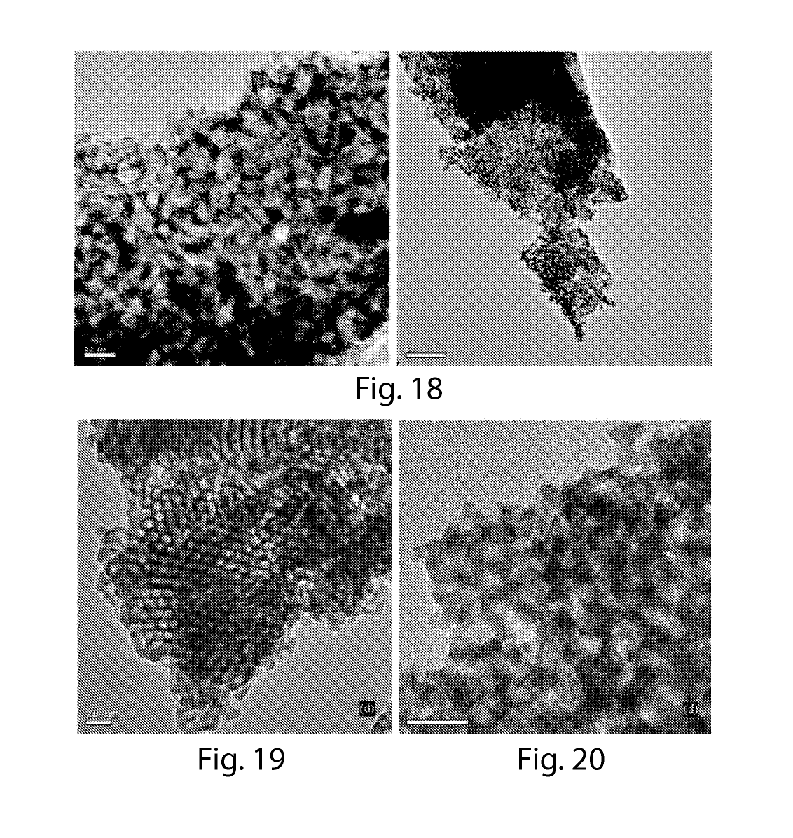

2.a) 0.212 moles of EtOH+0.025 moles of THF+0.025 moles of HCl (FIG. 18)

The preferred composition is that indicated as 1.a).

As it is argued from the above reported TEM images, if ethanol and small water amounts are used as solvent the structure of mixed oxide is clearly more ordered than THF+HCl without water. Another important aspect is related to the evaporation time of the solvent or gelification of the matrix inside of the furnace at controlled temperature and humidity. For composition 1 we can see in fact as the pore imparted order increases with increasing of the time within the furnace. Such phenomenon does not seem to occur for composition 2, even if the phenomenon would need to be studied in detail for this composition.

The specific object of the present invention is a ternary magnesium and niobium based oxide compound characterized by a mesoporous structure. In particular, the pores of such mesoporous compound are homogenously distributed in the amorphous structure in geometrically ordered and long-range way. The pores possess shape and distribution similar to that of honeycomb. The distribution of the pore dimension is a monomodal distribution diameter being approximately 4-5.5 nm. The material according to the invention, as reported above, shows a high order degree in the pore distribution forming a continuous whole of honeycomb-like hexagonal cells.

According to a preferred embodiment, the compound according to the invention has the following atomic percentage composition: Mg_{11.1}Nb_{22.2}O_{66.7}.

A process for the preparation of a compound as above defined is a further object of the present invention, such process consisting of the following steps:

a) Preparation of the surfactant solution, preferably nonionic, in a suitable solvent;

b) Addition the solution of the step a) magnesium and niobium metallic precursors;

c) Solvent evaporation, preferably in air, under stable and controlled relative humidity conditions for a time period not shorter than that necessary to the formation of a gel phase.

d) Calcination, preferably in air, in order to eliminate the surfactant. Based on the evaporation conditions of step c), the phase gel can be formed just after a few days. Generally, the ordered structure of the mesoporous material of the invention is obtained in approximately 3 days of evaporation, in the successive days only few not significant variation in the structure order were observed. However, the times of evaporation can be extended until approximately 30-40 days based on the used process, in particular evaporation, conditions.

The nonionic surfactant can be a polymeric nonionic triblock surfactant consisting of polyethylene oxide, polypropylene oxide, polyethylene oxide as, for example, the triblock polymer having the formula HO(CH₂CH₂O)₂₀(CH₂CH(OH)CH₂O)₇₀(CH₂CH₂O)₂₀H or HO(CH₂CH₂O)₁₀₆(CH₂CH(OH)CH₂O)₇₀(CH₂CH₂O)₁₀₆H.

Among the solvents that can be used, a mixture of ethanol and water or of ethanol, hydrochloric acid (diluted) and tetrahydrofuran can be used.

According to a preferred embodiment, magnesium and niobium metallic precursors are added at molar ratio variable from 1:2 up Nb excess equal to 10% molar.

Magnesium and niobium metallic precursors can be selected from MgCl₂ and NbCl₅ or Mg(OH)₂ and NbCl₅ pairs. Preferably when the pair of metallic precursors is MgCl₂ and NbCl₅, the solvent is a mixture of ethanol and water and, when the pair of metallic precursors is Mg(OH)₂ and NbCl₅, the solvent is a mixture of ethanol, hydrochloric acid (diluted) and tetrahydrofuran.

The temperature of evaporation can vary from 40 to 50° C. The evaporation can be carried out, preferably in air, under stable and controlled relative humidity conditions variable from 40% to 60%.

The calcination can be carried out at a temperature lower than the temperature of compound crystallization.

The use of as above defined compound in condenser or capacitor, materials for hydrogen confinement or materials for energy storage in form of electromagnetic wave is a further object of the present invention.

The present invention now will be described by an illustrative, but not limitative, way, according to its preferred embodiments with particular reference to the figures of the attached drawings:

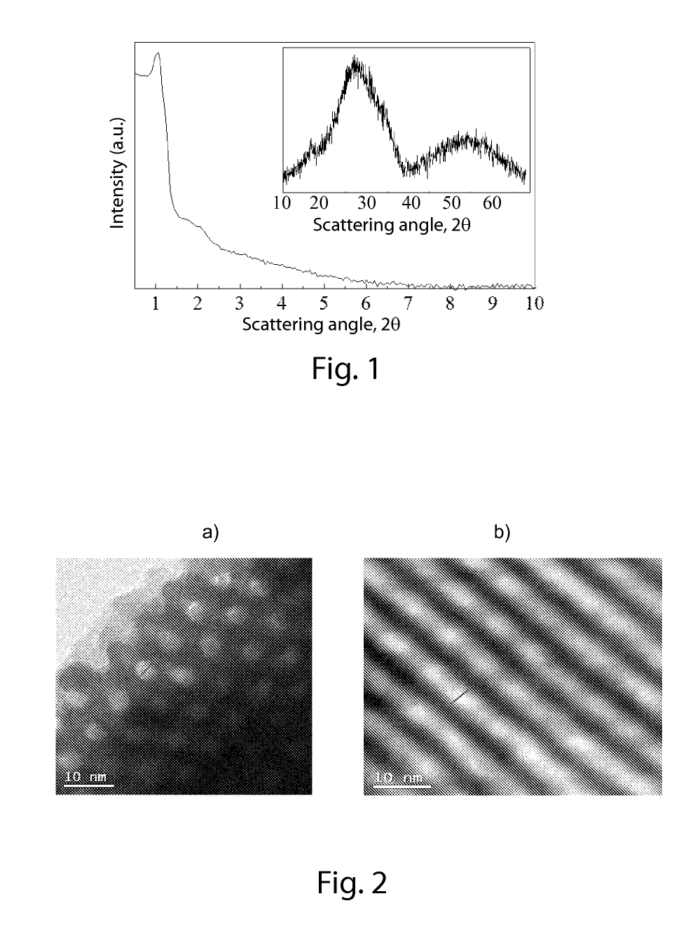

FIG. 1 shows x-ray diffraction patterns (using a CuKα X-ray radiation source) at low angles and, in the box, at high angles of the as synthesized material of example 1.

FIG. 2 shows TEM images of the material (sample V) of example 1. Frontal (a) and longitudinal (b) views of the as synthesized material of example 1.

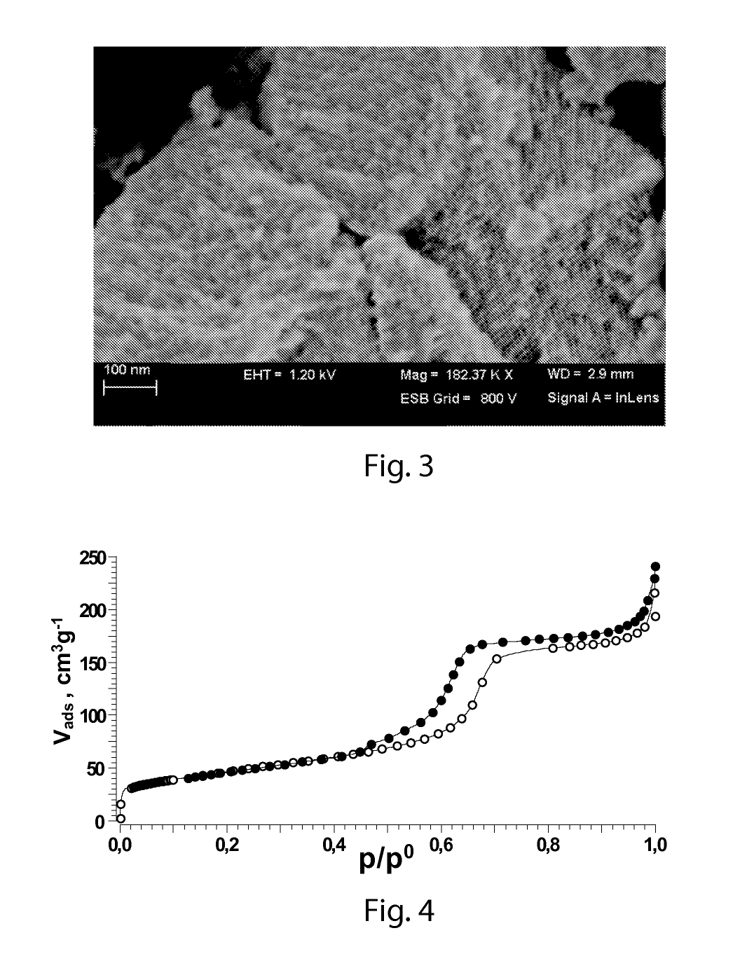

FIG. 3 shows SEM image of the material (sample V) of example 1. The image shows both a frontal and longitudinal views of the material morphology as synthesized following the example 1.

FIG. 4 shows the profile of N₂ adsorption/desorption isotherm for material (sample V) of example 1. The hysteresis corresponds to IV type (IUPAC).

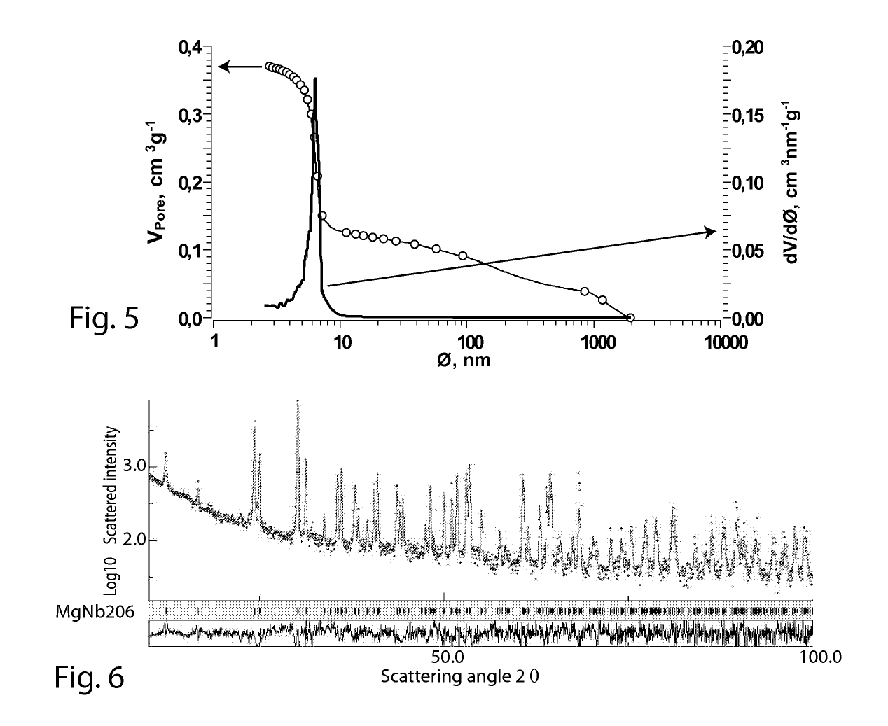

FIG. 5 shows the analysis of the pore volume (values reported on the left y axis) and the distributions of the pore sizes (right y axis in figure). A monomodal distribution of the pore diameter of the material can be observed according to (sample V) example 1, values around 5.5 nm.

FIG. 6 shows XRD measure (CuKα) of the material (sample V) according the example 1 and interpolation profile of data obtained according to the Rietveld Method for the quantitative evaluation of the microstructural properties.

FIG. 7 shows TEM image of sample III prepared of example 3 using P123 surfactant, i.e. HO(CH₂CH₂O)₂₀(CH₂CH—(OH)CH₂O)₇₀(CH₂CH₂O)₂₀H, with AMW 5800 average molecular weight.

FIG. 8 shows the TEM image of sample X prepared of example 4 using F127 surfactant, i.e. HO(CH₂CH₂O)₁₀₆(CH₂CH—(OH)CH₂O)₇₀(CH₂CH₂O)₁₀₆H, AMW:12.600.

FIG. 9 shows the N₂ physi-adsorption/desorption curve of sample III of the example 3. Surface area: 159.37 m²/g.

FIG. 10 shows the N₂ physi-adsorption/desorption curve of sample X of the example 4. Surface area: 155.61 m²/g.

FIG. 11 shows the TEM+XRD (CuKα) image of sample V, prepared following the example 1 using 0,212 moles of ethanol and 0,0167 moles of water as solvents. TEM and XRD analyses have been acquired for the sample after the heat treatment at 500° C.

FIG. 12 shows the TEM+XRD (CuKα) image of sample II, prepared of example 5 after heat treatment at 500° C.

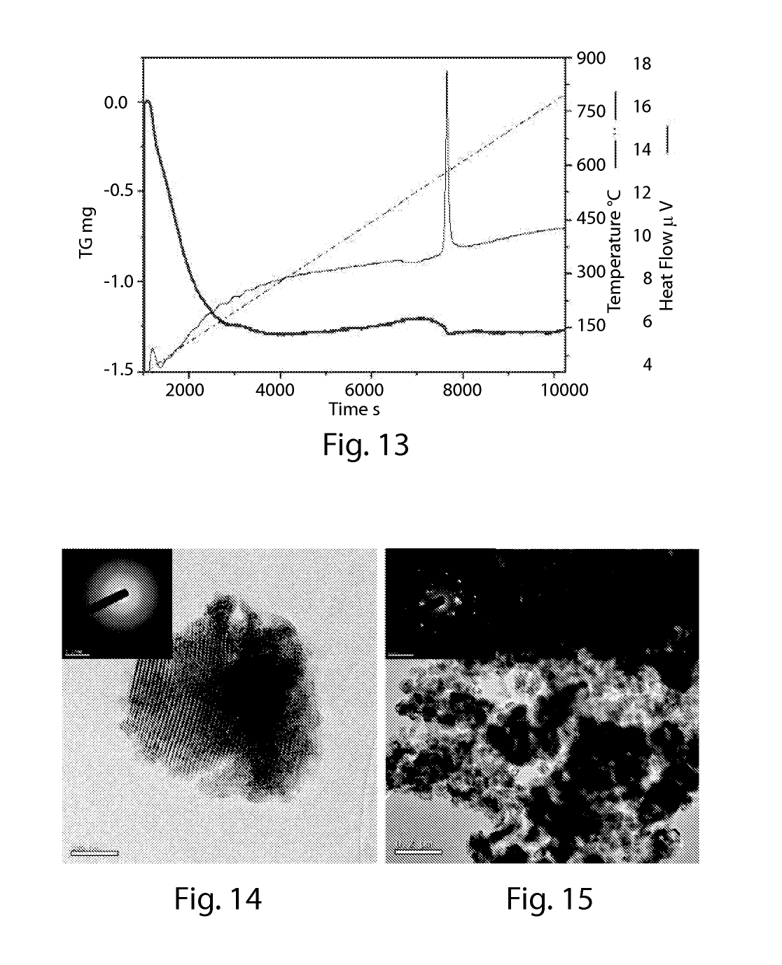

FIG. 13 shows the calorimetric signal (black continuous line in bold letter) and gravimetric (black continuous line) as a function of the time (X axis) and Temperature (black dotted line) for sample V of example 1.

FIG. 14 and FIG. 15 show the TEM images of sample V prepared of example 1. FIG. 14 refers to the as prepared sample, FIG. 15 refers to the sample subjected to crystallization.

FIG. 16 shows the TEM images of the materials prepared using 0.212 moles of ethanol and 0.0167 moles of water as solvent. On the left the sample III of example 3 evaporated in 3 days and on the right the sample V of example 1 evaporated in 38 days, respectively, are shown.

FIG. 17 shows the TEM images of the materials prepared using 0.212 moles of ethanol and 0.061 moles of water as solvent. On the left the sample IV of example 2 evaporated in 3 days and on the right the sample VI of example 8 evaporated in 33 days, respectively, are shown.

FIG. 18 shows the TEM images of the inventive materials prepared using 0.212 moles of ethanol, 0.025 moles of THF, 0.088 moles of water and 0.025 moles of HCl as solvent. On the left the sample VII of example 6 evaporated in 3 days and on the right the sample VIII of example 7 evaporated in 26 days, respectively, are shown.

FIG. 19 shows the TEM image of sample III of example (0.3 ml H₂O), evaporated in 3 instead of 38 days.

FIG. 20 shows the TEM image of sample IV of material prepared following the example 2 (1.1 ml H₂O).

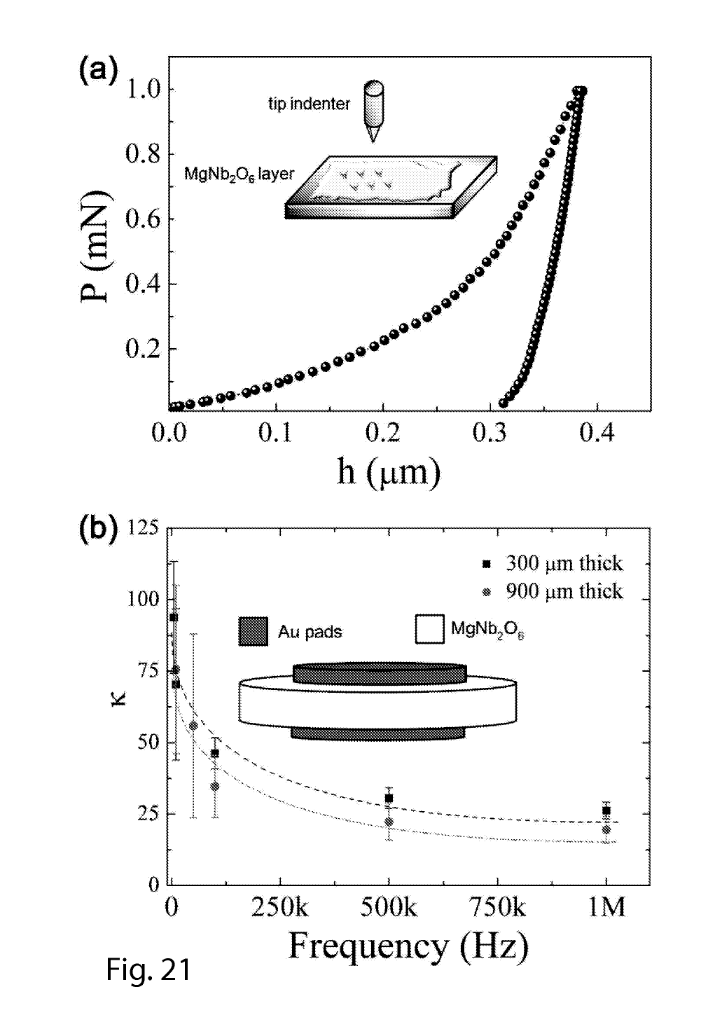

FIG. 21 shows a) Representative load (P)—displacement (h) nanoindentation curve performed at the surface of a layer of as-synthesized Mg—Nb oxide mesoporous material, together with a schematic of the indentation process. (b) Variation of the dielectric constant (k) with frequency, at room temperature, in two sets of MgNb₂O₆ films with different thicknesses. A schematic representation of the Metal-Insulator-Metal structure employed for estimating the dielectric constant is also shown.

### EXAMPLE 1

### Process for the Preparation of Mg and Nb Ternary Oxide According to the Present Invention: Sample V (FIGS. 1-6, 14-15)

Mg and Nb mesoporous oxide (Mg: Nb=1:2), with Mg_{11.11}Nb_{22.2}O_{66.7} atomic percentage composition is prepared via EISA (Evaporation-Induced Self-Assembly), by “soft template” type method, according to operating strategy similar to that used by Tokumitsu Katou and coworkers [16] for a different Nb and Ta based system.

These methods involve the assembling of the mesoporous matrix starting from a solution wherein the surfactant, a nonionic co-polymer, results in the formation of micelle forms and the formation of solid metallic oxide from their precursors.

From a preparative point of view, the synthesis was carried out according to the below reported procedure:

1 g of surfactant, a tri-block copolymer ((HO(CH₂CH₂O)₂₀(CH₂CH—(OH)CH₂O)₇₀(CH₂CH₂O)₂₀H, P123) was dissolved, under stirring at room temperature, in 12.4 ml of ethanol and 0.3 ml of H₂O.

To this solution MgCl₂ and NbCl₅ are added (0.0025 and 0.005 moles, respectively) as metal precursors and the as-prepared system was kept under stable and vigorous stirring.

The resulting solution was then transferred in a Petri disc and evaporated for 38 days in air at 40° C. under humidity controlled conditions from 40 to 60%.

The obtained compound was then calcined in air at 500° C. for 5 hours for the degradation and then removal of the surfactant.

Characterization

The characterization by X-Rays Diffraction was carried out using a Rigaku D/Max diffractometer according to Bragg-Brentano geometry equipped with a tube for emission of CuKα X-ray radiation and graphite monochromator on the diffracted beam.

The X-ray diffraction patterns of the sample treated at 500° C. (FIG. 1) disclose the absence of a short-range periodic three-dimensional structure (absence of crystalline peaks, according to Bragg diffraction signals, in 10<2θ<60 range) and it is presumable the typical amorphous nature of the mesoporous structures. The presence of two shoulders at low angles (1.5<2θ<2.5) reveals instead a long-range ordered matrix, due to the regular disposition of the pore distribution.

The TEM images (FIG. 2) and high resolution SEM of the mesoporous structure (FIG. 3) clearly show a highly ordered hierarchical matrix with pores having about 4 nm diameter, never obtained up to now for Mg and Nb based ternary oxide.

The N2 physisorption measures at 77K are carried out with a Sorptomatic 1990 Fisons apparatus.

The sample was subjected to complete degassing for 18 hours at the temperature of 350° C. The isotherms of N₂ adsorption-desorption (77 K) results in the hysteresis profile showed in FIG. 4. BET measures reveal a surface area of 169.12 m²/g.

The two peaks in FIG. 5 show a monomodal distribution of the pore diameter with values of 5.5 nm.

Finally, a further characterization of the sample was carried out through the monitoring of the heating of the sample up to 800° C. with a TG/DTA Setaram Labsys instrument. The analysis shows an exothermic peak typical of the crystallization phenomenon occurring at the temperature of approximately 620° C. The X-ray analysis of the crystallized sample, reported in FIG. 6 shows the successful formation of the MgNb₂O₆ crystallographic phase. XRD measures, after an accurate analysis of the crystallographic peaks, allowed to outline that, at the end of the treatment, only one crystallographic phase correspondent to MgNb₂O₆ is present.

### EXAMPLE 2

### Process for the Preparation of Mg and Nb Ternary Oxide According to the Present Invention: Sample IV (FIGS. 17 on the Left and 20)

The mesoporous oxide of Mg and Nb (Mg:Nb=1:2), with Mg_{11.1}Nb_{22.2}O_{66.7} atomic percentage composition was prepared via EISA (Evaporation-Induced Self-Assembly).

From a preparative point of view, the synthesis was carried out according to the below reported procedure:

1 g of surfactant, a tri-block copolymer ((HO(CH₂CH₂O)₂₀(CH₂CH—(OH)CH₂O)₇₀(CH₂CH₂O)₂₀H, P123) was dissolved, under stirring at room temp., in 12.4 ml of ethanol and 1.1 ml of H₂O. To this solution NbCl₅ and MgCl₂ are added (0.0025 and 0.005 moles, respectively) as metal precursors and the as-prepared system was kept under stable and vigorous stirring.

The resulting solution was then transferred in a Petri disc and evaporated for 3 days in air at 40° C. and under humidity controlled conditions from 40 to 60%.

The obtained compound was then calcined in air at 500° C. for 5 hours for the degradation and removal of the surfactant.

In this experiment we introduced a higher water amount respect to that used in example 1, with a gelation time of 3 days. TEM images reported in FIGS. 19 and 20 show that the two structures are both mesoporous and ordered, but the order degree is different for the two samples. The material of example 1 has a surface area of approximately 169.12 m²/g, while the material of example 2 has a surface area of approximately 146.44 m²/g. Such values are clearly higher than literature reported data (12 m²/g).

### EXAMPLE 3

### Process for the Preparation of Mg and Nb Ternary Oxide According to the Present Invention: Sample III (FIGS. 7, 9, 16 on the left and 19)

The mesoporous oxide of Mg and Nb (Mg:Nb=1:2), with Mg_{11.1}Nb_{22.2}O_{66.7} atomic percentage composition was prepared via EISA (Evaporation-Induced Self-Assembly).

From a preparative point of view, the synthesis was carried out according to the below reported procedure:

1 g of surfactant, a tri-block copolymer ((HO(CH₂CH₂O)₂₀(CH₂CH—(OH)CH₂O)₇₀(CH₂CH₂O)₂₀H, P123) was dissolved, under stirring at room temp., in 12.4 ml of ethanol and 0.3 ml of H₂O. To this solution NbCl₅ and MgCl₂ are added (0.005 and 0.0025 moles, respectively) as metal precursors and the as-prepared system was kept under stable and vigorous stirring.

The resulting solution was then transferred in a Petri disc and evaporated for 3 days in air at 40° C. and under humidity controlled conditions from 40 to 60%.

The obtained compound was then calcined in air at 500° C. for 5 hours for the degradation and removal of the surfactant.

### EXAMPLE 4

### Process for the Preparation of Mg and Nb Ternary Oxide According to the Present Invention: Sample III (FIGS. 7, 9, 16 on the Left and 19)

The mesoporous oxide of Mg and Nb (Mg:Nb=1:2), with Mg_{11.1}Nb_{22.2}O_{66.7} atomic percentage composition was prepared via EISA (Evaporation-Induced Self-Assembly).

From a preparative point of view, the synthesis was carried out according to the below reported procedure:

1 g of surfactant, a tri-block copolymer ((HO(CH₂CH₂O)₂₀(CH₂CH—(OH)CH₂O)₇₀(CH₂CH₂O)₂₀H, P123) was dissolved, under stirring at room temp., in 12.4 ml of ethanol and 0.3 ml of H₂O. To this solution NbCl₅ and MgCl₂ are added (0.005 and 0.0025 moles, respectively) as metal precursors and the as-prepared system was kept under stable and vigorous stirring.

The resulting solution was then transferred in a Petri disc and evaporated for 3 days in air at 40° C. and under humidity controlled conditions from 40 to 60%.

The obtained compound was then calcined in air at 500° C. for 5 hours for the degradation and removal of the surfactant.

### EXAMPLE 5

### Process for the Preparation of Mg and Nb Ternary Oxide According to the Present Invention: Sample II (FIG. 12)

The mesoporous oxide of Mg and Nb (Mg:Nb=1:2), with Mg_{11.1}Nb_{22.2}O_{66.7} atomic percentage composition was prepared via EISA (Evaporation-Induced Self-Assembly).

From a preparative point of view, the synthesis was carried out according to the below reported procedure:

1 g of surfactant, a tri-block copolymer ((HO(CH₂CH₂O)₂₀(CH₂CH—(OH)CH₂O)₇₀(CH₂CH₂O)₂₀H, P123) was dissolved, under stirring at room temp., in 12.4 ml of ethanol and 0.3 ml of H₂O. To this solution NbCl₅ and MgCl₂ are added (0.005 and 0.0025 moles, respectively) as metal precursors and the as-prepared system was kept under stable and vigorous stirring.

The resulting solution was then transferred in a Petri disc and evaporated for 3 days in air at 40° C. and without humidity control.

The obtained compound was then calcined in air at 500° C. for 5 hours for the degradation and removal of the surfactant.

### EXAMPLE 6

### Process for the Preparation of Mg and Nb Ternary Oxide According to the Present Invention: Sample VII (FIG. 18 on the Left)

The mesoporous oxide of Mg and Nb (Mg:Nb=1:2), with Mg_{11.1}Nb_{22.2}O_{66.7} atomic percentage composition was prepared via EISA (Evaporation-Induced Self-Assembly).

From a preparative point of view, the synthesis was carried out according to the below reported procedure:

1 g of surfactant, a tri-block copolymer ((HO(CH₂CH₂O)₂₀(CH₂CH—(OH)CH₂O)₇₀(CH₂CH₂O)₂₀H, P123) was dissolved, under stirring at room temp., in 12.4 ml of ethanol. To this solution NbCl₅ and MgCl₂ are added (0.005 and 0.0025 moles, respectively) as metal precursors and the as-prepared system was kept under stable and vigorous stirring.

The resulting solution was then transferred in a Petri disc and evaporated for 3 days in air at 40° C. and under humidity controlled conditions from 40 to 60%.

The obtained compound was then calcined in air at 500° C. for 5 hours for the degradation and removal of the surfactant.

### EXAMPLE 7

### Process for the Preparation of Mg and Nb Ternary Oxide According to the Present Invention: Sample VIII (FIG. 18 on the Right)

The mesoporous oxide of Mg and Nb (Mg:Nb=1:2), with Mg_{11.1}Nb_{22.2}O_{66.7} atomic percentage composition was prepared via EISA (Evaporation-Induced Self-Assembly).

From a preparative point of view, the synthesis was carried out according to the below reported procedure:

1 g of surfactant, a tri-block copolymer ((HO(CH₂CH₂O)₂₀(CH₂CH—(OH)CH₂O)₇₀(CH₂CH₂O)₂₀H, P123) was dissolved, under stirring at room temp., in 12.4 ml of ethanol. To this solution NbCl₅ and Mg(OH)₂ are added (0.005 and 0.0025 moles, respectively) as metal precursors, previously dissolved in 2 ml of THF and 2.5 ml of HCl and the as-prepared system was kept under stable and vigorous stirring.

The resulting solution was then transferred in a Petri disc and evaporated for 26 days in air at 40° C. and under humidity controlled conditions from 40 to 60%.

The obtained compound was then calcined in air at 500° C. for 5 hours for the degradation and removal of the surfactant.

### EXAMPLE 8

### Process for the Preparation of Mg and Nb Ternary Oxide According to the Present Invention: Sample VI (FIG. 17 on the Right)

The mesoporous oxide of Mg and Nb (Mg:Nb=1:2), with Mg_{11.1}Nb_{22.2}O_{66.7} atomic percentage composition was prepared via EISA (Evaporation-Induced Self-Assembly).

From a preparative point of view, the synthesis was carried out according to the below reported procedure:

1 g of surfactant, a tri-block copolymer ((HO(CH₂CH₂O)₂₀(CH₂CH—(OH)CH₂O)₇₀(CH₂CH₂O)₂₀H, P123) was dissolved, under stirring at room temp., in 12.4 ml of ethanol and 1.1 ml of H₂O. To this solution NbCl₅ and MgCl₂ are added (0.005 and 0.0025 moles, respectively) as metal precursors and the as-prepared system was kept under stable and vigorous stirring.

The resulting solution was then transferred in a Petri disc and evaporated for 33 days in air at 40° C. and under humidity controlled conditions from 40 to 60%.

The obtained compound was then calcined in air at 500° C. for 5 hours for the degradation and removal of the surfactant.

### EXAMPLE 9

### Mechanical Properties and Dielectric Capacity of the Mesoporous Material According to the Present Invention Prepared as Described of Example 3, Sample III

To measure the mechanical properties of the material according to the present invention, a layer of magnesium and niobium oxide material, with a thickness of about 10 μm, was deposited onto the surface of a Si substrate by drop casting a suspension of mesoporous powder dispersed in polyethylene glycol. The hardness (H) and reduced Young's modulus (Eᵣ) were evaluated by nanoindentation, using an UMIS system from Fischer-Cripps Laboratories equipped with a Berkovich pyramidal-shaped diamond tip. The experiments were performed in the load control mode and the value of maximum applied force was 1 mN, sufficiently small to ensure that the maximum penetration depth during the tests was below one tenth of the overall layer thickness. The “thermal drift” during nanoindentation was kept below 0.05 nm s⁻¹. Proper corrections for the contact area (calibrated with a fused quartz specimen), instrument compliance, and initial penetration depth were applied. The values of H and Eᵣ were determined from the load-displacement curves using the method of Oliver and Pharr. The elastic recovery was evaluated as the ratio between the elastic and the total (elastic+plastic) indentation energies, Wₑₗ/W ANₜₒₜ. These energies were calculated from the nanoindentation curves as the areas between the unloading segment and the displacement axis (Wel) and between the loading segment and the displacement axis (Wₜₒₜ). The presented results correspond to an average of 50 indentations.

The relative dielectric constant was estimated by performing a capacitive investigation by placing the dielectric material between two metals, Metal-Insulator-Metal (MIM) in the frequency range from 1 kHz to 1 MHz. Highly ordered Mg—Nb oxide films with two different thicknesses (300 and 900 pm) were prepared and two gold electrodes were deposited on both sides of the samples, as depicted in FIG. 21b, in order to obtain the MIM structure. The electrodes were deposited by thermal evaporation in high vacuum, at a nominal pressure around 5×10⁻⁶ Torr and patterned by means of a shadow mask interposed between the sample and the crucible during the evaporation process. Capacitance measurements were performed at room temperature on both pellets using an Agilent 4284A LCR Meter apparatus. To obtain shape and thickness homogenous pellets, the calcined powders were subjected to 150 bar pressure for 15 min each one

Mechanical Characterization

The mechanical properties of the as synthesized Mg—Nb oxide material were determined by nanoindentation and the obtained results were correlated with previous reported BET data. A representative load-displacement nanoindentation curve of the mesoporous Mg—Nb oxide material is shown in FIG. 21A. The obtained values of hardness and the reduced Young's modulus are H=340±20 MPa e Eᵣ=12.5±1.0 GPa, respectively

The reduced Young's modulus takes into account the elastic displacements of the sample (with Young's modulus E and Poisson's ratio v) and the indenter diamond tip, (with elastic constants Er-1140 GPa and vᵢ=0.07). The relationship between Eᵣ and E can be expressed as:

1/Eᵣ=(1−v²)/E+(1−vᵢ²)/Eᵢ (1)

For most ferroelectric ceramics and metal oxides analogous to Mg—Nb, such as MgO or Nb₂O₅, the Poisson's ratio is around 0.2. This value would be surely lower if the material would be porous. Assuming that v is about 0.2, the Young's modulus of the mesoporous Mg—Nb oxide would be 12 GPa, thus in practice very similar to Eᵣ.

The porosity level is known to have a strong influence on the elastic constants of metallic and ceramic materials. In a first approximation, it has been shown that:

Eₚₒᵣₒᵤₛ/E_{bulk}=(pₚₒᵣₒᵤₛ/p_{bulk} (2)

where pₚₒᵣₒᵤₛ/p_{bulk} is the relative density; n=2 for open-celled foams or sponge-like, whereas n=3 for materials exhibiting an array of pores arranged forming a honeycomb hexagonal array normal to the surface. The relative density is related to the porosity volume fraction:

pₚₒᵣₒᵤₛ/p_{bulk}=1−P (3)

where:

P=Cₚᵥ/(Cₚᵥ+1/p_{bulk}) (4)

Here Cₚᵥ denotes the cumulative pore volume, as determined by BET analysis, which for investigated material is Cₚᵥ=0.399 cm³ g⁻¹ Taking into account that the bulk density of MgNb₂O₆ is 5 g cm⁻³, the relative density of the mesoporous magnesium and niobium oxide particles is pₚₒᵣₒᵤₛ/p_{bulk}=0.334.

The Young's modulus of bulk MgNb₂O₆ is approximately 150 GPa. Using equation (2), a value n of approximately 2.3 is obtained. This exponent is similar to the values reported for template mesoporous thin films with ordered domains of honeycomb-like hexagonal pore arrangements exhibiting orientational disorder, a microstructure similar to our case.

As to the hardness, the value obtained in mesoporous Mg—Nb oxide (H=340 MPa) is also significantly lower than Vickers hardness reported for the bulk (H=7.1 GPa (ref. 39)). The decrease of the hardness with porosity is also effect known and reported in literature and has been modelled using finite element simulations of nanoindentation curves. An equation analogous to equation (2) can be used in order to correlate the elastic deformation of the porous structure with that of the bulk material.

σₚₒᵣₒᵤₛ=C₂σ_{bulk} ((pₚₒᵣₒᵤₛ/p_{bulk})^{m} (5)

where C₂=0.3 and m=1.5 for a material with opened pores (open-cell) but not uniformly distributed. Although the relation between hardness and plastic deformation in bulk ceramic oxide corresponds to H_{bulk}˜1.6σ_{bulk}, a quantitative relation between the hardness and the deformation in the porous materials must be still established. Some workers consider that in porous structures the indenter tip is not completely constrained by the surrounding material regardless of eventual densification during the measure. Then the nanoindentation would be equivalent to a uniaxial compression test wherein Hₚₒᵣₒᵤₛ=σₚₒᵣₒᵤₛ. In our case and using the above-mentioned assumptions, equation (5) would give m value of approximately 1.3, which is a quite reasonable value.

Finally, the elastic and total indentation energies are 0.030±0.005 nJ and 0.120±0.005 nJ, respectively, thus the elastic recovery is Wₑₗ/Wₜₒₜ=0.25. This parameter indicates how much energy is released from the material after being loaded and it could be of particular interest in applications subjected to impact loading. Remarkably, this value is of the same order of magnitude as the elastic recovery measured in electrodeposited fully dense CuNi films.

Capacitance Characterization

The variation of the dielectric constant as a function of frequency is shown in FIG. 21b. As expected the value of k progressively decreases with frequency. The dielectric constant for the mesoporous Mg—Nb oxide is ˜25 at 1 MHz, about half of the value reported by Singh and Bajpai for bulk MgNb₂O₆ This difference can be ascribed to the porosity level of the mesoporous magnesium niobate. In fact, for ceramic materials the dielectric constant can be related to porosity as follows

k_{bulk}=kₚₒᵣₒᵤₛ(1+1.5 P) (6)

where P is the porosity of the ceramic material calculated from eqn (4).

Since P=0.666, our capacitance measurements (kₚₒᵣₒᵤₛ=25) would lead to a value of dielectric constant k_{bulk}=50, thus in good agreement with the results of Singh and Bajpai.

Nanoindentation measurements indicate a hardness value of 340±20 MPa and a Young's modulus of 12.5±1.0 GPa. The H value is significantly lower than the Vickers hardness reported for bulk MgNb₂O₆ (H=7.1 GPa), as expected from the high porosity degree of this material. The correlation between Young's modulus and relative density is consistent with the honeycomb-like hexagonal pore arrangements as revealed by TEM characterization. The dielectric constant of the mesoporous sample, measured in the frequency range from 1 kHz to 1 MHz, is rather high (k˜25 at 1 MHz) and it is in agreement with the k value expected from the porosity level of this material. Regarding the thermal stability, the amorphous powders crystallize to the columbite phase MgNb₂O₆ at about 600° C., but at this calcination temperature a partial loss of periodicity takes place and the surface area decreases to 99±2 m²g⁻¹. At higher temperature (800° C.), the periodic order of the mesostructure is completely lost, while the surface area becomes much lower, i.e. <20 m²_{g}⁻¹.

### BIBLIOGRAPHY

[1] Norin R., Arbin C G, Nolander B., Acta Chem Scand, 1972, 26:3389
[2] Ogawa H., Kan A., Ishihara S., Higashida Y., J Eur Ceram Soc, 2003, 23:2485
[3] Pullar R C, J Am Ceram Soc, 2009, 92:563.
[4] You Y C, Park H L, Song Y G, Moon H S, Kim G C, J Mater Sci Letter, 1994, 13:1487
[5] Shanker V., Ganguli A K, Bull. Mater. Sci, 2003, 26:741
[6] Swartz S L., Shrout T R, Mater Res Bull, 1982, 17:1245
[7] Joy P A, Materials Letters, 1997, 32:347
[8] Dolci F, Baricco M, Edwards P P, Giamello A N D, Int J Hydrogen Energy, 2008, 33:3085
[9] Rahman M W, Livraghi S, Dolci F, Baricco M, Giamello A N D, Int J Hydrogen Energy, 2011, 36:7932
[10] Ananta S., Brydson R, Thomas NW, J Eur Ceram Soc, 1999, 19:355
[11] Kong L B, Ma J, Huang H, Zhang R F, Journal of Alloys and Compounds, 2002, 340:L1-L4
[12] Malfatti L, Innocenzi P, J Sol-Gel Sci Technol, 2011, 60:226.
[13] Camargo E R, Longo A N D, Leite R, J. Sol-Gel Technol, 2000, 17:111-121
[14] Fang T H, Hsiao Y J, Chang Y S, Ji L W, Kang S H, Current opinion in solid state and materials science, 2008, 12:51
[15] Zang Y C, Zhou X N, Wang X, J Sol Gel Sci Technol, 2009, 50:348
[16] Katou T, Lu D, Kondo J N and Domen K, J. Mater. Chem., 2002, 12:1480

1. A magnesium and niobium based ternary oxide compound having a mesoporous nature.

2. The compound according to claim 1, the pores of the mesoporous compound are homogenously distributed in an amorphous matrix in a geometrically ordered way.

3. The compound according to claim 1, the compound has the following atomic percentage composition: Mg_{11.1}Nb_{22.2}O_{66.7}.

4. A process for preparation of the compound of claim 1, the process comprising:
preparing a solution of surfactant in suitable solvent;
adding to the prepared solution magnesium and niobium metallic precursors;
evaporating the solvent under stable and controlled relative humidity conditions for a time period not shorter than that necessary to the formation of a gel phase;
calcining in order to eliminate the surfactant.

5. The process according to claim 4, wherein the surfactant is a nonionic surfactant.

6. The process according to claim 5, wherein the nonionic surfactant is a polymeric nonionic triblock surfactant consisting of polyethylene oxide, polypropylene oxide, polyethylene oxide.

7. The process according to claim 6, wherein the polymeric nonionic triblock surfactant has formula: HO(CH₂CH₂O)₂₀(CH₂CH—(OH)CH₂O)₇₀(CH₂CH₂O)₂₀H or HO(CH₂CH₂O)₁₀₆(CH₂CH—(OH)CH₂O)₇₀(CH₂CH₂O)₁₀₆H.

8. The process according to claim 4, wherein the suitable solvent is a mixture of ethanol and water or of ethanol, hydrochloric acid, tetrahydrofuran.

9. The process according to claim 4, wherein the magnesium and niobium metallic precursors are added at molar ratio variable from 1:2 up to Nb excess equal to 10% molar.

10. The process according to claim 4, wherein the magnesium and niobium metallic precursors are selected from MgCl₂ and NbCl₅ or Mg(OH)₂ and NbCl₅ pairs

11. The process according to claim 4, wherein
when the metallic precursor pair is MgCl₂ and NbCl₅, the solvent is a mixture of ethanol and water; and
when the metallic precursor pair is Mg(OH)₂ and NbCl₅, the solvent is a mixture of ethanol, hydrochloric acid, tetrahydrofuran.

12. The process according to claim 4, wherein the evaporating and calcining steps are carried out in air.

13. The process according to claim 4, wherein the evaporating is carried out at a temperature from 40 to 50° C.

14. The process according to claim 4, wherein the evaporating is carried out under stable and controlled relative humidity conditions from 40 to 60%.

15. The process according to claim 4, wherein the calcining is carried out at a temperature lower than crystallization temperature of the compound.

16. A method comprising:
using the compound of claim 1 in a capacitor or condenser.

17. A method comprising:
using the compound of claim 1 in materials for hydrogen confinement.

18. A method comprising:
using the compound of claim 1 in materials for energy storage in form of electromagnetic wave.

19. A capacitor or condenser comprising the compound of claim 1

20. A material for hydrogen confinement comprising the compound of claim 1.

21. A material for energy storage in form of electromagnetic wave comprising the compound of claim 1.
